(19) United States
(12) Patent Application Publication
(10) Pub. No.: US 2025/0330294 A1
(43) Pub. Date: Oct. 23, 2025

(54) METHOD AND DEVICE FOR DETERMINING TRANSMISSION RESOURCE IN UNLICENSED FREQUENCY BAND

(71) Applicant: Beijing Xiaomi Mobile Software Co., Ltd., Beijing (CN)

(72) Inventors: Wensu ZHAO, Beijing (CN); Qun ZHAO, Beijing (CN)

(21) Appl. No.: 18/870,338

(22) PCT Filed: Jun. 2, 2022
(86) PCT No.: PCT/CN2022/097011

§ 371 Date: Nov. 27, 2024

(51) Int. Cl. H04L 5/00; H04L 1/1867; H04W 72/25; H04W 74/0808

(52) U.S. Cl. CPC H04L 5/0098; H04L 1/1896; H04W 72/25; H04W 74/0808

(57) ABSTRACT

A method for determining a transmission resource in an unlicensed frequency band, the method includes: determining a resource, for transmitting a transport block (TB) in a resource selection window.

### CROSS-REFERENCE TO RELATED APPLICATIONS

The present application is a U.S. National Stage of International Application No. PCT/CN2022/097011, filed on Jun. 2, 2022, the contents of all of which are incorporated herein by reference in their entireties for all purposes.

### BACKGROUND OF THE INVENTION

It is necessary to select the predetermined number of resources for transmitting a transport block (TB) at first before the TB is transmitted in a communication system.

### SUMMARY OF THE INVENTION

A method for determining a transmission resource in an unlicensed frequency band, and a device are provided in examples of the present disclosure.

In a first aspect, a method for determining a transmission resource in an unlicensed frequency band is provided in an example of the present disclosure. The method is performed by a terminal device, and includes: determining a resource for transmitting a transport block (TB) in a resource selection window.

In a second aspect, a communication device is provided in an example of the present disclosure. The communication device includes a processor and a memory, where the memory stores a computer program, and the processor performs the computer program stored in the memory to cause the communication device to execute the method of the first aspect above.

In a third aspect, a non-transitory computer-readable storage medium is provided in an example of the present disclosure. The computer-readable storage medium is configured to store one or more programs, where the one or more programs is configured to be executed by one or more processors of a processing device, and the one or more programs includes instructions, when executed by the processing device, cause the processing device to execute the method of the first aspect above.

### BRIEF DESCRIPTION OF DRAWINGS

In order to more clearly illustrate the technical solutions in the examples or the background of the present disclosure, the accompanying drawings required to be used in the examples or the background of the present disclosure will be described below.

FIG. 1 is a schematic architecture diagram of a communication system according to an example of the present disclosure;

FIG. 2 is a schematic flow diagram of a method for determining a transmission resource in an unlicensed frequency band according to an example of the present disclosure;

FIG. 3 is a schematic flow diagram of a method for determining a transmission resource in an unlicensed frequency band according to another example of the present disclosure;

FIG. 4 is a schematic flow diagram of a method for determining a transmission resource in an unlicensed frequency band according to another example of the present disclosure;

FIG. 5 is a schematic diagram of a process for determining a transmission resource in an unlicensed frequency band according to an example of the present disclosure;

FIG. 6 is a schematic flow diagram of a method for determining a transmission resource in an unlicensed frequency band according to another example of the present disclosure;

FIG. 7 is a schematic flow diagram of a method for determining a transmission resource in an unlicensed frequency band according to another example of the present disclosure;

FIG. 8 is a schematic diagram of a process for determining a transmission resource in an unlicensed frequency band according to another example of the present disclosure;

FIG. 9 is a schematic structural diagram of a communication device according to an example of the present disclosure;

FIG. 10 is a schematic structural diagram of a communication device according to another example of the present disclosure; and

FIG. 11 is a schematic structural diagram of a chip according to an example of the present disclosure.

### DETAILED DESCRIPTION OF THE INVENTION

When corresponding resources are selected to transmit the TB according to an existing resource selection mechanism of an R16 sidelink in an unlicensed frequency band, listen before talk (LBT) may fail on channels corresponding to the corresponding resources, resulting in an incapability of transmitting the TB. As a result, how to reliably transmit the TB in the unlicensed frequency band is a pressing issue that needs to be addressed. As for this, the present disclosure related to the technical field of communication, provides a method for determining a transmission resource in an unlicensed frequency band, and a device.

For ease of understanding, the terms involved in the present disclosure are firstly introduced.

### 1. Transport Block (TB)

A TB is a data unit on an interface between a medium access control (MAC) sublayer and a physical layer, and is carried by a transmission channel.

### 2. Listen Before Talk (LBT)

LBT, also known as “listen before transmit”, is a technology widely used in radio communication. Before starting transmission, a radio transmitter firstly listens to a radio environment of the radio transmitter to detect whether a channel is idle. If the channel is busy, the radio transmitter waits for the channel to be idle before transmission, so as to avoid a channel access conflict and achieve channel spectrum sharing.

### 3. Hybrid Automatic Repeat Request (HARQ)

An HARQ is a technology formed by combining forward error correction (FEC) with an automatic repeat request (ARQ). A receiver saves received data and requests a transmitter to retransmit data in a case of decoding failure. The receiver merges the retransmitted data with the previously received data before decoding.

In order to better understand a method for determining a transmission resource in an unlicensed frequency band disclosed in an example of the present disclosure, a communication system applicable to the example of the present disclosure will be firstly described below.

With reference to FIG. 1, a schematic architecture diagram of a communication system according to an example of the present disclosure is shown. The communication system may include, but not limited to, a network device 11 and a terminal device 12. The number and form of the devices shown in FIG. 1 are merely for illustrative purposes and do not constitute a limitation to the example of the present disclosure. In an actual application, the communication system may include two or more network devices and two or more terminal devices. The communication system shown in FIG. 1 including a network device 11 and a terminal device 12 will be described as an example.

It should be noted that the technical solution of the example of the present disclosure is applicable to various communication systems, for example, a long term evolution (LTE) system, a 5th generation (5G) mobile communication system, a 5G new radio (NR) system, or other future novel mobile communication systems.

The network device 11 in the example of the present disclosure is an entity for transmitting or receiving a signal on a network side. For example, the network device 11 may be an evolved NodeB (eNB), a transmission reception point (TRP), a next generation NodeB (gNB) in an NR system, a base station in other future mobile communication systems, or an access node in a wireless fidelity (WiFi) system. A specific technology and specific device form used by the network device 11 are not limited in the example of the present disclosure. The network device 11 according to the example of the present disclosure may consist of a central unit (CU) and a distributed unit (DU). The CU may also be referred to as a control unit. Protocol layers of the network device 11, such as the base station, may be separated by a CU-DU structure, functions of some protocol layers are centrally controlled by the CU, functions of a remaining part or all protocol layers are distributed in the DU, and the DU is centrally controlled by the CU.

The terminal device 12 in the example of the present disclosure is an entity for receiving or transmitting a signal on a user side, such as a mobile phone. The terminal device 12 may also be referred to as a terminal, user equipment (UE), a mobile station (MS), a mobile terminal (MT), etc. The terminal device 12 may be a car having a communication function, a smart car, a mobile phone, a wearable device, a portable android device (Pad), a computer having a wireless receiving and transmitting function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in smart home, etc. A specific technology and specific device form used by the terminal device 12 are not limited in the example of the present disclosure.

It may be understood that the communication system described in the example of the present disclosure is for the purpose of more clearly describing the technical solution of the example of the present disclosure, and does not constitute a limitation to the technical solution provided in the example of the present disclosure. Those of ordinary skill in the art may know that with evolution of a system architecture and emergence of a new service scenario, the technical solution provided in the example of the present disclosure is also applicable to similar technical problems.

Generally, the number of resources for transmitting a TB may be determined by the terminal device according to an indication of an MAC layer in a process of resource selection. For example, assuming that it is indicated by the MAC layer that at most 3 resources are selected as the resources for transmitting the TB, at most 3 candidate resources may be merely selected by the terminal device from a candidate resource set in a resource selection window to transmit the TB.

LBT needs to be performed on channels corresponding to the resources before the TB is transmitted by the selected resources in an unlicensed frequency band, so as to determine that the channels are in an idle state, and avoid a channel access conflict. Thus, failure of TB transmission is avoided. However, the number of the resources for transmitting the TB, indicated by the MAC layer, is small, and a probability of LBT success on the channels corresponding to the resources for transmitting the TB is small. Thus, reliability of TB transmission is reduced.

The example of the present disclosure will be further described now in combination with the accompanying drawings and the particular embodiments.

The examples will be described in detail herein and are illustratively shown in the accompanying drawings. When the following descriptions relate to the accompanying drawings, unless otherwise specified, the same numerals in different accompanying drawings denote the same or similar elements. The embodiments described in the following examples do not denote all embodiments consistent with the examples of the present disclosure. On the contrary, the embodiments are merely examples of a device and a method consistent with some aspects of the present disclosure as detailed in the appended claims.

The terms used in the examples of the present disclosure are merely to describe the particular examples, instead of limiting the examples of the present disclosure. The singular forms such as “a/an” and “the” used in the examples and the appended claims of the present disclosure are also intended to include the plural forms, unless otherwise clearly stated in the context. It should further be understood that the term “and/or” used herein refers to and includes any of one or more of the associated listed items or all possible combinations.

Depending on the context, the words “if” and “in response to” as used herein can be interpreted as “at the time of” or “when” or “in response to determining”.

The examples of the present disclosure will be described in detail below, and the examples are shown in the accompanying drawings, throughout which the same or similar reference numerals denote the same or similar elements. The examples described with reference to the accompanying drawings are illustrative below and are intended to explain the present disclosure, instead of being construed as limiting the present disclosure.

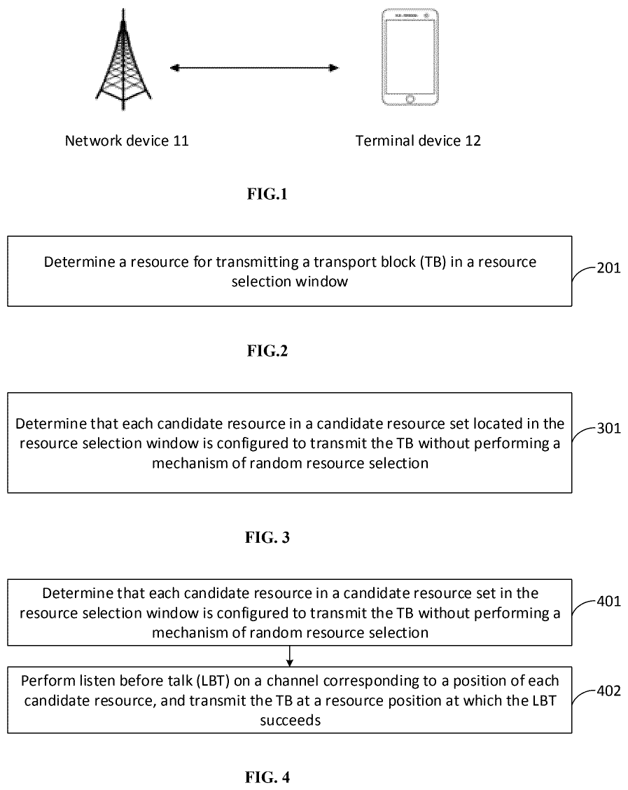

With reference to FIG. 2, a schematic flow diagram of a method for determining a transmission resource in an unlicensed frequency band according to an example of the present disclosure is shown. The method is performed by a terminal device. As shown in FIG. 2, the method may include, but not limited to:
step 201, a resource for transmitting a TB in a resource selection window are determined.

Generally, the number of the resources for transmitting the TB may be determined by the terminal device according to an indication of an MAC layer in a process of resource selection. For example, assuming that it is indicated by the MAC layer that at most 3 resources are selected as the resources for transmitting the TB, at most 3 candidate resources may be merely selected by the terminal device from a candidate resource set in the resource selection window to transmit the TB. LBT needs to be performed on channels corresponding to the resources before the TB is transmitted by the selected resources in the unlicensed frequency band, so as to determine that the channels are in an idle state, and avoid a channel access conflict. Thus, failure of TB transmission is avoided. However, the number of the resources for transmitting the TB, indicated by the MAC layer, is small, and a probability of LBT success in the resources for transmitting the TB is small. Thus, reliability of TB transmission is reduced.

In the present disclosure, it may be directly determined by the terminal device that each candidate resource in the resource selection window is configured to transmit the TB without performing a mechanism of random resource selection. Alternatively, the mechanism of random resource selection may be performed by the terminal device, and the resources available for transmitting the TB, which are the sum of the number L of randomly selected resources indicated by the MAC layer and a first preset offset value, may be determined by the terminal device from the candidate resource set in the resource selection window, i.e. N=L+the first preset offset value. N is the number of the resources available for transmitting the TB, and the first preset offset value is an integer greater than 0. Then, LBT may be performed by the terminal device on the channel corresponding to each determined resource, and the TB may be transmitted by the terminal device by a resource on which the LBT succeeds when the LBT is successfully performed on the channel corresponding to a certain resource. Thus, a probability of TB transmission is increased, and it is ensured that the TB is reliably transmitted.

The candidate resources may be resources that are not locked by other communication devices and may be configured to transmit the TB. Each candidate resource may include one or more time slots in a time domain; or each candidate resource may include one or more subchannels in a frequency domain; or each candidate resource may include one or more interlaced resource block (IRB) indexes in a resource block (RB) set in a frequency domain; or each candidate resource may include one or more IRB indexes in a plurality of RB sets in a frequency domain.

Alternatively, the number of the resources available for transmitting the TB in the resource selection window may be determined by the terminal device according to a second preset offset value and the number of reserved resources indicated by SCI. That is, the number of candidate resources in the resource selection window is determined. For example, it may be determined that the number of the resources available for transmitting the TB in the resource selection window is the sum of the number of reserved resources indicated by the SCI and the second offset value.

In the present disclosure, the resources for transmitting the TB in the resource selection window may be determined by the terminal device, then LBT may be performed by the terminal device on the channels corresponding to the resources, and the TB may be transmitted by the terminal device on a resource on which the LBT succeeds. Thus, reliability of TB transmission is improved.

With reference to FIG. 3, a schematic flow diagram of a method for determining a transmission resource in an unlicensed frequency band according to an example of the present disclosure is shown. The method is performed by a terminal device. As shown in FIG. 3, the method may include, but not limited to:
step 301, it is determined that each candidate resource in a candidate resource set located in a resource selection window is configured to transmit the TB without performing a mechanism of random resource selection.

For a specific explanation of the candidate resources, reference may be made to the detailed description of any example of the present disclosure, which is not repeated herein.

In the present disclosure, in order to increase a probability of TB transmission, each candidate resource in the candidate resource set located in the resource selection window may be directly determined as a source for transmitting the TB by the terminal device without performing the mechanism of random resource selection. That is, each candidate resource in the candidate resource set may be used as a resource for transmitting the TB for a first time, and may also be used as a resource for retransmitting the TB. Then, LBT may be performed by the terminal device on the channel corresponding to each resource in the candidate resource set until the LBT succeeds. That is, the TB may be transmitted on a resource on which the LBT succeeds. Thus, each candidate resource in the resource selection window is determined as the resource for transmitting the TB, such that the number of the resources for transmitting the TB is increased, and a probability of LBT success is increased. Thus, a probability of the TB transmission is increased, and reliability of the TB transmission is ensured.

In the present disclosure, it may be determined by the terminal device that each candidate resource in the candidate resource set located in the resource selection window is configured to transmit the TB without performing the mechanism of random resource selection. Thus, the number of the resources for transmitting the TB is increased, such that the probability of the LBT success is increased. Thus, the probability of the TB transmission is increased, and the reliability of the TB transmission is ensured.

With reference to FIG. 4, a schematic flow diagram of a method for determining a transmission resource in an unlicensed frequency band according to an example of the present disclosure is shown. The method is performed by a terminal device. As shown in FIG. 4, the method may include, but not limited to:
step 401, it is determined that each candidate resource in a candidate resource set located in a resource selection window is configured to transmit a TB without performing a mechanism of random resource selection.

In the present disclosure, for a specific explanation of step 401, reference may be made to the detailed description of any example of the present disclosure, which is not repeated herein.

Step 402, LBT is performed on a channel corresponding to a position of each candidate resource, and the TB is transmitted at a resource position at which the LBT succeeds.

In the present disclosure, the LBT may be performed by the terminal device on the channel corresponding to each candidate resource in the resource selection window, and when the LBT on the channel corresponding to a candidate resource is successfully performed for a first time, the TB may be transmitted for the first time by the candidate resource. When the TB is successfully transmitted by the candidate resource, the LBT may be not performed by the terminal device on the resources on which the LBT is not performed.

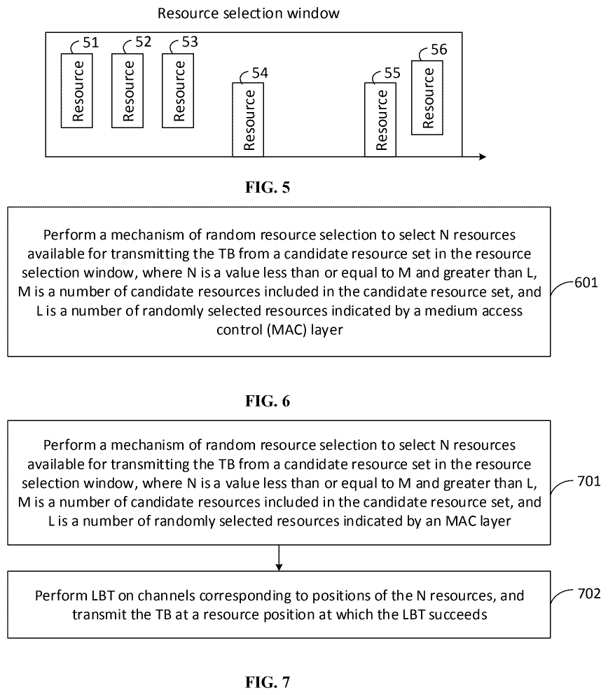

For example, as shown in FIG. 5, a resource selection window includes 6 candidate resources. Each resource may correspond to one or more time slots, a direction indicated by an arrow in FIG. 5 is a direction of the slots from front to back, and corresponding resources are sequentially determined as a first candidate resource 51, a second candidate resource 52, a third candidate resource 53, a fourth candidate resource 54, a fifth candidate resource 55, and a sixth candidate resource 56 according to an order of the time slots from front to back. After LBT is unsuccessfully performed by the terminal device on a channel corresponding to the first candidate resource 51, LBT continues being performed by the terminal device on a channel corresponding to the second candidate resource 52 until LBT is successfully performed by the terminal device on a channel corresponding to the fourth candidate resource 54, and a TB is transmitted by the terminal device by the fourth candidate resource 54. When the current TB is successfully transmitted, LBT may not be performed on channels corresponding to the fifth candidate resource 55 and the sixth candidate resource 56.

Optionally, when an initial transmission fails and a retransmission is supported by the terminal device, LBT may continue being performed by the terminal device on channels corresponding to candidate resources on which LBT is not performed. When LBT is successfully performed on a channel corresponding to a candidate resource, the TB may be retransmitted by the terminal device for a first time by the candidate resource. When a first retransmission succeeds, LBT may be not performed by the terminal device on resources on which LBT is not performed.

Optionally, when the first retransmission fails and multiple retransmissions, for example, two retransmissions, are supported by the terminal device, LBT continues being performed by the terminal device on channels corresponding to candidate resources on which LBT is not performed. When LBT is successfully performed on a channel corresponding to a candidate resource, the TB may be retransmitted by the terminal device for a second time by the candidate resource. When the multiple retransmissions of the TB fail, it is determined that a current TB transmission fails.

Optionally, the current TB may not be transmitted in a case where the LBT on the channel corresponding to each candidate resource fails.

In the present disclosure, it may be determined by the terminal device that each candidate resource in the candidate resource set of the resource selection window is configured to transmit the TB without performing the mechanism of random resource selection, then the LBT may be performed by the terminal device on the channel corresponding to the position of each candidate resource, and the TB may be transmitted by the terminal device at the resource position at which the LBT succeeds. Thus, the number of the resources for transmitting the TB is increased, such that a probability of LBT success is increased. Thus, a probability of TB transmission is increased, it is ensured that the TB is reliably transmitted, and efficiency of TB transmission is improved.

With reference to FIG. 6, a schematic flow diagram of a method for determining a transmission resource in an unlicensed frequency band according to an example of the present disclosure is shown. The method is performed by a terminal device. As shown in FIG. 6, the method may include, but not limited to:
step 601, a mechanism of random resource selection is performed, and N resources available for transmitting the TB are selected from a candidate resource set in the resource selection window. N is a value less than or equal to M and greater than L, M is the number of candidate resources included in the candidate resource set, and L is the number of randomly selected resources indicated by an MAC layer.

In the present disclosure, the value of N may be determined by the terminal device according to the L and a first preset offset value, and then the mechanism of random resource selection may be performed by the terminal device to randomly select the N resources for transmitting the current TB from the candidate resource set in the resource selection window.

Moreover, the first preset offset value may be determined by the terminal device according to an indication of a network device, or the first preset offset value may be determined as a value in a preconfigured value set by the terminal device according to sidelink control information (SCI) or downlink control information (DCI). The value set may include a plurality of offset values, and an index number corresponding to an offset value in the value set may be configured in the SCI or DCI information to indicate the first preset offset value that may be used by the terminal device.

Optionally, the N resources randomly selected by the terminal device may be configured to initially transmit the TB or retransmit the TB. That is, it is not specified which of the N resources are configured to initially transmit the TB and which are configured to retransmit the TB. Instead, LBT is performed on the channels corresponding to the N resources one by one until the LBT is successfully performed for a first time. The resource on which the LBT is successfully performed for the first time may be configured to initially transmit the TB, and remaining resources on which LBT is not performed are determined as resources for retransmitting the TB. Thus, the N resources are the sum of the number of retransmission resources and the number of initial transmission resources.

Moreover, when a retransmission based on HARQ feedback is supported by the terminal device, a time gap between every two adjacent resources of the N resources may be set to be greater than or equal to a first set value in order to avoid interference during TB transmission and ensure reliability of the TB transmission. The two adjacent resources may be two logically adjacent resources, and the two resources may be separated by a plurality of time slots on a physical time slots.

Moreover, the first set value may be determined according to a time gap a between an end position of a last symbol of a first resource transmitted by a physical sidelink share channel (PSSCH) and a start position of a first symbol of a resource of a corresponding physical sidelink feedback channel (PSFCH), and the sum of PSFCH receiving and processing time and time b of TB retransmission preparation time of a sidelink (retransmission preparation time includes necessary physical channel multiplexing and any TX-RX/RX-TX conversion time). For example, the first set value may be a time gap between the end position of the last symbol of the first resource transmitted by the PSSCH and the start position of the first symbol of the resource of the corresponding PSFCH, plus the sum of PSFCH receiving and processing time and TB retransmission preparation time of the sidelink.

Optionally, the K resources in the N resources may be used by the terminal device to initially transmit the TB, and the remaining N−K resources may be used by the terminal device to retransmit the TB. K is an integer greater than or equal to 1 and less than or equal to N.

Moreover, when a retransmission based on HARQ feedback is supported by the terminal device, a time gap between every two resources of the N−K retransmission resources may be set to be greater than or equal to the first set value and a time gap between one initial transmission resource from the K initial transmission resources on which the LBT succeeds and a first retransmission resource of the N−K retransmission resources may be set to be greater than or equal to the first set value in order to avoid interference during TB transmission and ensure reliability of the TB transmission.

Moreover, LBT is not performed by the terminal device on channels corresponding to positions of the N−K retransmission resources in a case where the LBT on channels corresponding to positions of the K initial transmission resource fails.

Optionally, when channel occupancy time (COT) sharing is supported by the terminal device, the time gap between every two adjacent resources of the N resources may be set to be less than or equal to a second set value. The second set value may be equal to 16 us, 25 us, 9 us, 0, etc., so as to ensure that a time gap between adjacent resources for transmitting the TB is short and meet regulatory requirements. Thus, the channel is prevented from being occupied by other different systems (such as action hotspot WiFi), and thus a success rate of channel access of the LBT is ensured.

In the present disclosure, the mechanism of random resource selection may be performed by the terminal device to select the N resources available for transmitting the TB from the candidate resource set in the resource selection window. Thus, the number of the resources for transmitting the TB is increased, such that a probability of LBT success is increased. Thus, a probability of TB transmission is increased, it is ensured that the TB is reliably transmitted, and efficiency of TB transmission is improved.

With reference to FIG. 7, a schematic flow diagram of a method for determining a transmission resource in an unlicensed frequency band according to an example of the present disclosure is shown. The method is performed by a terminal device. As shown in FIG. 7, the method may include, but not limited to:
step 701, a mechanism of random resource selection is performed, and N resources available for transmitting the TB are selected from a candidate resource set in the resource selection window. N is a value less than or equal to M and greater than L, M is the number of candidate resources included in the candidate resource set, and L is the number of randomly selected resources indicated by an MAC layer.

In the present disclosure, for a specific explanation of step 701, reference may be made to the detailed description of any example of the present disclosure, which is not repeated herein.

Step 702, LBT is performed on channels corresponding to positions of N resources, and the TB is transmitted at a resource position at which the LBT succeeds.

In the present disclosure, LBT may be performed by the terminal device on the channel corresponding to each resource in the K resources one by one in a case where the K resources in the N resources are configured to initially transmit the TB and N−K resources are configured to retransmit the TB. When LBT is successfully performed on a channel corresponding to a candidate resource for a first time, the TB may be initially transmitted by the candidate resource. After an initial transmission succeeds, LBT may be not performed by the terminal device on resources on which LBT is not performed in the K resources and the N−K resources for retransmitting the TB.

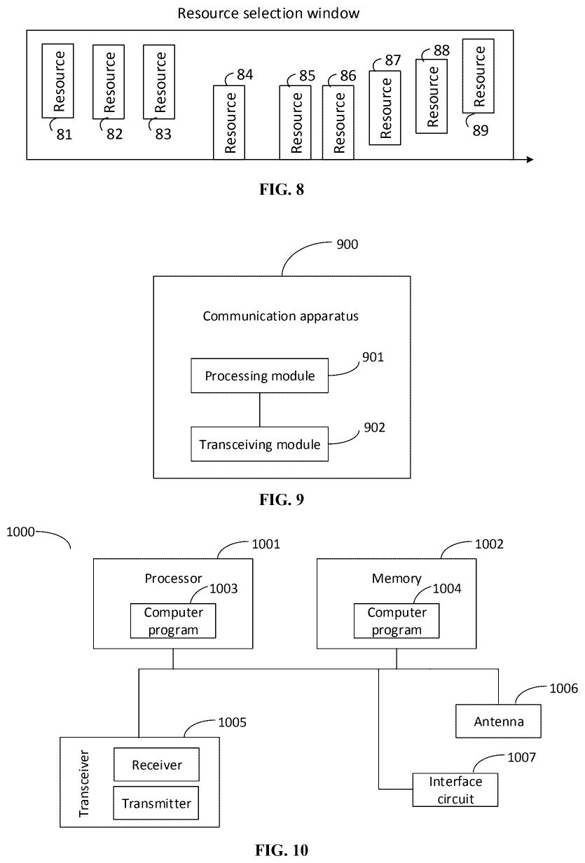

For example, as shown in FIG. 8, a resource selection window includes 9 candidate resources. Each resource may correspond to one or more time slots, a direction indicated by an arrow in FIG. 8 is a direction of the time slots from front to back, and corresponding resources are sequentially determined as a first candidate resource 81, a second candidate resource 82, a third candidate resource 83, a fourth candidate resource 84, a fifth candidate resource 85, a sixth candidate resource 86, a seventh candidate resource 87, an eighth candidate resource 88, and a ninth candidate resource 89 according to an order of the time slots from front to back. Assuming that the first 5 candidate resources are randomly selected by the terminal device for TB transmission, the first 3 candidate resources are configured to initially transmit the TB, i.e. K=3, and the last 2 candidate resources are configured to retransmit the TB, i.e. N−K=2. After LBT is unsuccessfully performed by the terminal device on a channel corresponding to the first candidate resource 81, LBT may continue being performed by the terminal device on a channel corresponding to the second candidate resource 82. When LBT is successfully performed by the terminal device on the channel corresponding to the second candidate resource 82, a TB may be initially transmitted by the second candidate resource 82. When an initial transmission succeeds, LBT may be stopped on the third candidate resource 83, the fourth candidate resource 84, and the fifth candidate resource 85.

LBT may be performed by the terminal device on N−K resources for retransmitting the TB in a case where the initial transmission fails and a retransmission is supported by the terminal device. When LBT is successfully performed on a channel corresponding to a candidate resource for a first time, the TB is retransmitted by the candidate resource. After the retransmission succeeds, no LBT may be performed by the terminal device on resources on which LBT is not performed in the N−K resources.

For example, as shown in FIG. 8, the resource selection window includes 9 candidate resources, and the first 5 candidate resources are randomly selected by the terminal device for TB transmission. The first 3 candidate resources are configured to initially transmit the TB, i.e. K=3, and the last 2 candidate resources are configured to retransmit the TB, i.e. N−K=2. When the TB is initially transmitted unsuccessfully by the terminal device by the second candidate resource, LBT may be performed on a channel corresponding to the fourth candidate resource. When LBT is successfully performed on the channel corresponding to the fourth candidate resource, the TB may be retransmitted by the fourth candidate resource. When the TB is successfully retransmitted by the fourth candidate resource, LBT may be stopped on a channel corresponding to the fifth candidate resource. It may be understood that even if there is a resource on which LBT is not performed in the K resources, such as the third candidate resource, the resource is not used when the TB is retransmitted.

When a first retransmission fails and multiple retransmissions, for example, two retransmissions, are supported by the terminal device, LBT continues being performed by the terminal device on channels corresponding to candidate resources on which LBT is not performed in the N−K resources for retransmission. When LBT is successfully performed on a channel corresponding to a candidate resource, the TB may be retransmitted by the terminal device by the candidate resource for a second time. When the multiple retransmissions of the TB fail, it is determined that a current TB transmission fails.

The current TB may not be transmitted and LBT is not performed on the channels corresponding to the N−K resources for retransmission in a case where LBT performed on the channels corresponding to the K resources for initial transmission all fails.

The current TB may not be retransmitted in a case where LBT on the channels corresponding to the N−K resources for retransmission fails.

Optionally, LBT may be performed by the terminal device on the channels corresponding to the N resources in a case where the N resources are the sum of retransmission resources and initial transmission resources. When LBT is successfully performed on a channel corresponding to a candidate resource for the first time, the TB may be initially transmitted by the candidate resource. When the TB is successfully transmitted by the candidate resource, LBT may be not performed by the terminal device on the resources on which LBT is not performed.

LBT may be performed by the terminal device on remaining resources on which LBT is not performed in the N resources in a case where the initial transmission fails and a retransmission is supported by the terminal device. When LBT is successfully performed on a channel corresponding to a candidate resource for a first time, the TB is retransmitted by the candidate resource. After the retransmission succeeds, LBT on resources on which LBT is not performed in the N resources may be stopped by the terminal device.

In the present disclosure, the mechanism of random resource selection may be performed by the terminal device to select the N resources available for transmitting the TB from the candidate resource set in the resource selection window, then the LBT may be performed by the terminal device on the channels corresponding to the positions of the N resources, and the TB may be transmitted by the terminal device at the resource position at which the LBT succeeds. Thus, the number of the resources for transmitting the TB is increased, such that a probability of LBT success is increased. Thus, a probability of TB transmission is increased, it is ensured that the TB is reliably transmitted, and efficiency of TB transmission is improved.

With reference to FIG. 9, a schematic structural diagram of a communication device 900 according to an example of the present disclosure is shown. The communication device 900 shown in FIG. 9 may include a processing module 901 and a transceiving module 902. The transceiving module 902 may include a transmitting module and/or a receiving module. The transmitting module is configured to implement a transmitting function, the receiving module is configured to implement a receiving function, and the transceiving module 902 may implement the transmitting function and/or the receiving function.

It may be understood that the communication device 900 may be a terminal device, a device in a terminal device, or a device compatible with a terminal device.

The communication device 900 is at a terminal device side.

The processing module 901 is configured to determine a resource for transmitting a TB in a resource selection window.

Optionally, the processing module 901 is configured to:
determine that each candidate resource in a candidate resource set located in the resource selection window is configured to transmit the TB without performing a mechanism of random resource selection.

Optionally, the transceiving module 902, configured to perform LBT on a channel corresponding to a position of each candidate resource, and transmit the TB at a resource position at which the LBT succeeds.

Optionally, the processing module 901 is further configured to:
perform a mechanism of random resource selection to select N resources available for transmitting the TB from a candidate resource set in the resource selection window, where N is a value less than or equal to M and greater than L, M is the number of candidate resources included in the candidate resource set, and L is the number of randomly selected resources indicated by an MAC layer.

Optionally, the transceiving module 902 is further configured to:
perform LBT on channels corresponding to positions of the N resources, and transmit
the TB at a resource position at which the LBT succeeds.

Optionally, the processing module 901 is further configured to:
determine a value of N according to L and a first preset offset value.

Optionally, the processing module 901 is further configured to:
determine the first preset offset value according to an indication of a network device; or
determine the first preset offset value to be a value in a preconfigured value set according to SCI or DCI.

Optionally, the N resources are the sum of the number of retransmission resources and the number of initial transmission resources.

Optionally, the processing module 901 is further configured to:
determine that a time gap between every two adjacent resources of the N resources is greater than or equal to a first set value in a case where a retransmission based on HARQ feedback is supported by a terminal device.

Optionally, the N resources include K initial transmission resources and N−K retransmission resources, where K is an integer greater than or equal to 1 and less than or equal to N.

Optionally, the processing module 901 is further configured to:
determine that a time gap between every two resources of the N−K retransmission resources is greater than or equal to a first set value and a time gap between one initial transmission resource from the K initial transmission resources on which LBT succeeds and a first retransmission resource of the N−K retransmission resources is greater than or equal to the first set value in a case where a retransmission based on HARQ feedback is supported by a terminal device.

Optionally, the transceiving module 902 is further configured to:
LBT is not performed by a terminal device on channels corresponding to positions of the N−K retransmission resources in a case where LBT on channels corresponding to positions of the K initial transmission resources fails.

Optionally, the processing module 901 is further configured to:
determine that the time gap between every two adjacent resources of the N resources is less than or equal to a second set value in a case where COT sharing is supported by the terminal device.

Optionally, the processing module 901 is further configured to:
determine the number of the resources available for transmitting the TB in the resource selection window according to a second preset offset value and the number of reserved resources indicated by the SCI.

In the present disclosure, the resources for transmitting the TB in the resource selection window may be determined by the terminal device, then LBT may be performed by the terminal device on the channels corresponding to the resources, and the TB may be transmitted by the terminal device on a resource on which the LBT succeeds. Thus, reliability of TB transmission is improved.

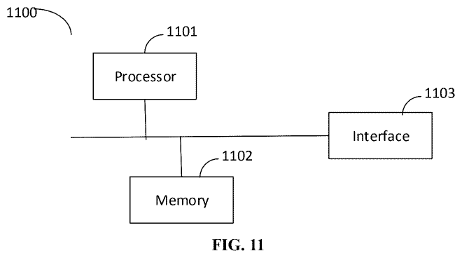

With reference to FIG. 10, a schematic structural diagram of another communication device 1000 according to an example of the present disclosure is shown. The communication device 1000 may be a terminal device, or a chip, a chip system or a processor that supports the terminal device to implement the method above. The device may be configured to implement the method described in the above method example, and reference may be made to the description in the above method example for details.

The communication device 1000 may include one or more processors 1001. The processor 1001 may be a general-purpose processor or a special-purpose processor, for example, a baseband processor or a central processor. The baseband processor may be configured to process a communication protocol and communication data, and the central processor may be configured to control the communication device (for example, a base station, a baseband chip, the terminal device, a terminal device chip, a DU or a CU) to execute a computer program and process data of the computer program.

Optionally, the communication device 1000 may further include one or more memories 1002. The memory may store a computer program 1004, and the computer program 1004 is executed by the processor 1001 to cause the communication device 1000 to execute the method described in the above method example. Optionally, data may be further stored by the memory 1002. The communication device 1000 and the memory 1002 may be arranged separately or may be integrated together.

Optionally, the communication device 1000 may further include a transceiver 1005 and an antenna 1006. The transceiver 1005 may be referred to as a transceiving unit, a transceiving machine, or a transceiving circuit, and is configured to implement receiving and transmitting functions. The transceiver 1005 may include a receiver and a transmitter. The receiver may be referred to as a receiving machine or a receiving circuit, and is configured to implement a receiving function, and the transmitter may be referred to as a transmitting machine or a transmitting circuit, and is configured to implement a transmitting function.

Optionally, the communication device 1000 may further include one or more interface circuits 1007. The interface circuit 1007 is configured to receive a code instruction and transmit the code instruction to the processor 1001. The code instruction is run by the processor 1001 to cause the communication device 1000 to execute the method described in the method example above.

The communication device 1000 is the terminal device: the processor 1001 is configured to perform step 201 in FIG. 2, step 301 in FIG. 3, step 401 in FIG. 4, step 601 in FIG. 6, and step 701 in FIG. 7.

In an implementation, a processor 1001 may include a transceiver for implementing receiving and transmitting functions. For example, the transceiver may be a transceiving circuit, an interface, or an interface circuit. The transceiving circuit, the interface, or the interface circuit for implementing the receiving and transmitting functions may be separated or integrated together. The transceiving circuit, the interface, or the interface circuit may be configured to read and write codes/data, or the transceiving circuit, the interface, or the interface circuit may be configured to transmit or transfer a signal.

In an implementation, a computer program 1003 may be stored by a processor 1001, and the computer program 1003 runs on the processor 1001 and may cause a communication device 1000 to execute the method described in the above method example. When the computer program 1003 may be solidified in the processor 1001, the processor 1001 may be implemented by hardware.

In an implementation, a communication device 1000 may include a circuit. The circuit may implement transmitting, receiving or communicating functions in the above method example. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), and an electronic device. The processor and the transceiver may also be manufactured according to various IC process technologies, for example, a complementary metal oxide semiconductor (CMOS), a n-metal-oxide-semiconductor (NMOS), a positive channel metal oxide semiconductor (PMOS), a bipolar junction transistor (BJT), a bipolar CMOS (BiCMOS), silicon germanium (SiGe) and gallium arsenide (GaAs).

The communication device 1000 described in the above example may be a network device or an intelligent relay, but the scope of the communication device described in the present disclosure is not limited to this, and a structure of the communication device may not be limited by FIG. 10. The communication device may be a stand-alone device or may be part of a large device. For example, the communication device may be:
(1) an independent IC, a chip, a chip system or a subsystem;
(2) a set having one or more ICs, which may optionally include a memory component for storing data and a computer program;
(3) an ASIC, such as modem;
(4) modules that may be embedded in other devices;
(5) a receiver, a terminal device, an intelligent terminal device, a cellular phone, a wireless device, a handset, a mobile unit, a vehicle-mounted device, a network device, a cloud device, and an artificial intelligence device; and
(6) another device.

For a case in which the communication device may be the chip or the chip system, reference may be made to the schematic structural diagram of a chip shown in FIG. 11. The chip shown in FIG. 11 includes a processor 1101 and an interface 1103. One or more processors 1101 may be provided, and a plurality of interfaces 1103 may be provided.

For a case in which the chip is configured to implement functions of a terminal device in the example of the present disclosure:
the interface 1103 is configured to perform step 402 in FIG. 4, and step 702 in FIG. 7.

Optionally, the chip further includes a memory 1102. The memory 1102 is configured to store necessary computer programs and data.

It may be further understood by those skilled in the art that various illustrative logical blocks and steps listed in the examples of the present disclosure may be implemented by means of electronic hardware, computer software, or a combination of the electronic hardware and the computer software. Whether such a function is implemented in hardware or software depends on a particular application and design requirements of the overall system. The functions may be implemented by those skilled in the art for each particular application by different methods, but such implementation should not be considered to fall beyond the scope of protection of the examples of the present disclosure.

The present disclosure further provides a readable storage medium storing an instruction. The instruction implements the functions of any one of the method examples above when executed by a computer.

The present disclosure further provides a computer program product. The computer program product implements the functions of any one of the method examples above when executed by a computer.

In the above examples, the functions may be fully or partially implemented by means of software, hardware, firmware, or any combination of the software, the hardware and the firmware. When implemented by means of the software, the functions may be fully or partially implemented in the form of the computer program product. The computer program product includes one or more computer programs. The flows or functions according to the examples of the present disclosure are fully or partially generated when the computer program is loaded or executed on the computer. The computer may be a general-purpose computer, a special-purpose computer, a computer network, or other programmable devices. The computer program may be stored in the computer-readable storage medium or transferred from one computer-readable storage medium to another computer-readable storage medium. For example, the computer program may be transferred from a website site, computer, server, or data center to another website site, compute, server, or data center in a wired means (for example, a coaxial cable, an optic fiber and a digital subscriber line (DSL)), or a wireless means (for example, infrared, radio and microwaves). The computer-readable storage medium may be any available media that may be accessed by a computer or data storage devices of servers, data centers, etc. that include one or more available media. The available media may be magnetic media (such as floppy disks, hard disks and magnetic tapes), optical media (such as digital video disks (DVDs)), or semiconductor media (such as solid state disks (SSDs)).

It may be understood by those skilled in the art that various numerical numbers involved in the present disclosure, such as first and second, are merely for the convenience of description, are not intended to limit the scope of the examples of the present disclosure, and also indicate the sequential order.

At least one in the present disclosure may further be described as one or more, and a plurality may be two, three, four, or more, which are not limited in the present disclosure. In the examples of the present disclosure, for a technical feature, technical features in the technical feature are distinguished by means of “first”, “second”, “third”, “A”, “B”, “C” and “D”, and the technical features described by “first”, “second”, “third”, “A”, “B”, “C” and “D” have no order of sequence or order of size.

Corresponding relations shown in each table in the present disclosure may be configured or predefined. Values of information in each table are merely examples, and may be configured to be other values, which are not limited in the present disclosure. When the corresponding relations between the information and each parameter are configured, it is not necessarily required to configure all the corresponding relations indicated in each table. For example, corresponding relations shown in some rows may not be configured in the tables in the present disclosure. For another example, appropriate deformation adjustments, such as splitting and merging, may be made on the basis of the above tables. Other names that may be understood by the communication device may also be used as the names of the parameters shown in the title of each table above, and other values or expression modes that may be understood by the communication device may also be used as values or expression modes of the parameters. When each table is implemented, other data structures may be used, such as array, queue, container, stack, linear list, pointer, linked list, tree, graph, structure, class, heap, or hash table.

Predefinition in the present disclosure may be understood as definition, preliminary definition, storage, pre-storage, pre-negotiation, pre-configuration, solidification, or pre-firing.

Those of ordinary skill in the art may appreciate that the units and algorithm steps of the examples described in combination with the examples disclosed herein may be implemented in electronic hardware, or a combination of computer software and electronic hardware. Whether these functions are executed in hardware or software depends on the specific application and design constraints of the technical solutions. Those skilled in the art may implement the functions described for each particular application according to different methods, but such implementation should not be considered to fall beyond the scope of the present disclosure.

Those skilled in the pertinent field may clearly understand that for convenience and brevity of description, specific working processes of the above systems, devices, and units described above may refer to corresponding processes in the above method examples, which is not repeated herein.

What are described above are merely particular embodiments of the present disclosure, but the scope of protection of the present disclosure is not limited to this. Any change or substitution that may be easily conceived by any person skilled in the art within the technical scope disclosed in the present disclosure should fall within the scope of protection of the present disclosure. Thus, the scope of protection of the present disclosure should be subject to the scope of protection of the claims.

1. A method for determining a transmission resource in an unlicensed frequency band, performed by a terminal device, the method comprising:
determining a resource for transmitting a transport block (TB) in a resource selection window.

2. The method of claim 1, wherein determining the resource for transmitting the TB in the resource selection window comprises:
determining that each candidate resource in a candidate resource set located in the resource selection window is configured to transmit the TB without performing a mechanism of random resource selection.

3. The method of claim 2, further comprising:
performing listen before talk (LBT) on a channel corresponding to a position of each candidate resource; and
transmitting the TB at a resource position at which the LBT succeeds.

4. The method of claim 1, further comprising:
performing a mechanism of random resource selection to select N resources available for transmitting the TB from a candidate resource set in the resource selection window, wherein N is a value less than or equal to M and greater than L, M is a number of candidate resources comprised in the candidate resource set, and L is a number of randomly selected resources indicated by a medium access control (MAC) layer.

5. The method of claim 4, further comprising:
performing LBT on channels corresponding to positions of the N resources; and
transmitting the TB at a resource position at which the LBT succeeds.

6. The method of claim 4, further comprising:
determining a value of N according to L and a first preset offset value.

7. The method of claim 6, further comprising:
determining the first preset offset value according to an indication of a network device; or
determining the first preset offset value to be a value in a preconfigured value set according to sidelink control information (SCI) or downlink control information (DCI).

8. The method of claim 4, wherein the N resources are a sum of a number of retransmission resources and a number of initial transmission resources.

9. The method of claim 8, further comprising:
determining that a time gap between every two adjacent resources of the N resources is greater than or equal to a first set value in a case where a retransmission based on hybrid automatic repeat request (HARQ) feedback is supported by the terminal device.

10. The method of claim 4, wherein the N resources comprise K initial transmission resources and N−K retransmission resources, wherein K is an integer greater than or equal to 1 and less than or equal to N.

11. The method of claim 10, further comprising:
determining that a time gap between every two resources of the N−K retransmission resources is greater than or equal to a first set value and a time gap between one initial transmission resource from the K initial transmission resources on which LBT succeeds and a first retransmission resource of the N−K retransmission resources is greater than or equal to the first set value, in a case where a retransmission based on HARQ feedback is supported by the terminal device.

12. The method of claim 10, further comprising:
not performing LBT by the terminal device on channels corresponding to positions of the N−K retransmission resources in a case where LBT on channels corresponding to positions of the K initial transmission resources fails.

13. The method of claim 8, further comprising:
determining that the time gap between every two adjacent resources of the N resources is less than or equal to a second set value in a case where channel occupancy time (COT) sharing is supported by the terminal device.

14. The method of claim 1, further comprising:
determining a number of resources available for transmitting the TB in the resource selection window according to a second preset offset value and a number of reserved resources indicated by sidelink control information (SCI).

15-28. (canceled)

29. A communication device, comprising:
one or more processors; and
a memory that stores a computer program, wherein
the one or more processors are collectively configured to:
determine a resource for transmitting a transport block (TB) in a resource selection window.

30. A non-transitory computer-readable storage medium storing one or more programs, wherein the one or more programs is configured to be executed by one or more processors of a processing device, and the one or more programs comprises instructions, when executed by the processing device, cause the processing device to:
determine a resource for transmitting a transport block (TB) in a resource selection window.

31. The communication device of claim 29, wherein the one or more processors are collectively configured to:
determine that each candidate resource in a candidate resource set located in the resource selection window is configured to transmit the TB without performing a mechanism of random resource selection.

32. The communication device of claim 31, wherein the one or more processors are collectively configured to:
perform listen before talk (LBT) on a channel corresponding to a position of each candidate resource; and
transmit the TB at a resource position at which the LBT succeeds.

33. The communication device of claim 29, wherein the one or more processors are collectively configured to:
perform a mechanism of random resource selection to select N resources available for transmitting the TB from a candidate resource set in the resource selection window, wherein N is a value less than or equal to M and greater than L, M is a number of candidate resources comprised in the candidate resource set, and L is a number of randomly selected resources indicated by a medium access control (MAC) layer.

34. The communication device of claim 33, wherein the one or more processors are collectively configured to:
perform LBT on channels corresponding to positions of the N resources; and
transmit the TB at a resource position at which the LBT succeeds.
